(19) United States
(12) Patent Application Publication
(10) Pub. No.: US 2021/0240029 A1
(43) Pub. Date: Aug. 5, 2021

(54) ELECTRONIC APPARATUS AND METHOD FOR MANUFACTURING THE SAME

(71) Applicant: Japan Display Inc., Tokyo (JP)

(72) Inventors: Genki ASOZU, Tokyo (JP); Toshiyuki HIGANO, Tokyo (JP)

(21) Appl. No.: 17/166,506

(22) Filed: Feb. 3, 2021

(30) Foreign Application Priority Data
Feb. 4, 2020 (JP) 2020-017154

(51) Int. Cl. G02F 1/1333; G02F 1/1335; G02F 1/1339

(52) U.S. Cl. CPC G02F 1/133305; G02F 1/133516; G02F 1/133528; G02F 1/133354; G02F 1/1339; G02F 1/133512

(57) ABSTRACT

An electronic apparatus comprising: a first flexible substrate; a second flexible substrate facing the first flexible substrate; and a first barrier film provided on a surface of the first flexible substrate that faces the second flexible substrate and formed by an inorganic insulating film, wherein the first flexible substrate has a superimposition region in which the first barrier film is provided and a non-superimposition region that is provided between a side surface of the first barrier film and a side surface of the first flexible substrate and in which the first barrier film is not provided.

### CROSS-REFERENCE TO RELATED APPLICATION

This application claims the benefit of priority from Japanese Patent Application No. 2020-017154 filed on Feb. 4, 2020, the entire contents of which are incorporated herein by reference.

### BACKGROUND

### 1. Technical Field

The present disclosure relates to an electronic apparatus and a method for manufacturing the same.

### 2. Description of the Related Art

Japanese Patent Application Laid-open Publication No. 2019-179102 A describes a liquid crystal display device that is configured by a resin substrate having flexibility and is capable of being folded. Such a display device is referred to as, for example, a sheet display. The sheet display includes a barrier film made of an inorganic material on a surface of the resin substrate in order to prevent entrance of oxygen and moisture.

The barrier film made of the inorganic material has lower flexibility than that of the resin substrate, and cracks can therefore be generated therein with stress applied to the resin substrate. Such cracks can be generated in the barrier film in outer shape cutting processing in a manufacturing process of the display device, for example.

### SUMMARY

An electronic apparatus according to an embodiment of the present disclosure includes a first flexible substrate, a second flexible substrate facing the first flexible substrate, and a first barrier film provided on a surface of the first flexible substrate that faces the second flexible substrate and formed by an inorganic insulating film. The first flexible substrate has a superimposition region in which the first barrier film is provided and a non-superimposition region that is provided between a side surface of the first barrier film and a side surface of the first flexible substrate and in which the first barrier film is not provided.

A method according to an embodiment of the present disclosure for manufacturing an electronic apparatus is disclosed. The electronic apparatus includes a first flexible substrate, and a second flexible substrate facing the first flexible substrate. The method includes forming a first barrier film formed by an inorganic insulating film on the first flexible substrate to form a superimposition region in which the first barrier film is provided and a non-superimposition region that is provided between a side surface of the first barrier film and a side surface of the first flexible substrate and in which the first barrier film is not provided, and bonding the first flexible substrate and the second flexible substrate and cutting the first flexible substrate and the second flexible substrate along the non-superimposition region.

### BRIEF DESCRIPTION OF THE DRAWINGS

FIG. 1 is a plan view schematically illustrating a display device according to a first embodiment;

FIG. 2 is a circuit diagram illustrating a pixel array in a display region;

FIG. 3 is a cross-sectional view illustrating the schematic cross-sectional configuration of the display device;

FIG. 4 is a cross-sectional view cut along line IV-IV′ in FIG. 1;

FIG. 5 is a flowchart illustrating an example of a method for manufacturing the display device according to the first embodiment;

FIG. 6 is a plan view schematically illustrating the display device before outer shape cutting;

FIG. 7 is a cross-sectional view cut along line VII-VII′ in FIG. 6;

FIG. 8 is a cross-sectional view for explaining an example of a method for manufacturing a display device according to a second embodiment;

FIG. 9 is a cross-sectional view schematically illustrating the display device according to the second embodiment;

FIG. 10 is a cross-sectional view for explaining an example of a method for manufacturing a display device according to a first modification of the second embodiment;

FIG. 11 is a cross-sectional view schematically illustrating the display device according to the first modification of the second embodiment;

FIG. 12 is a cross-sectional view for explaining an example of a method for manufacturing a display device according to a third embodiment;

FIG. 13 is a cross-sectional view schematically illustrating the display device according to the third embodiment; and

FIG. 14 is a cross-sectional view schematically illustrating a display device according to a second modification of the third embodiment.

### DETAILED DESCRIPTION

Modes for carrying out the present disclosure (embodiments) will be described in detail with reference to the drawings. Contents described in the following embodiments do not limit the present disclosure. Components described below include those that can be easily conceived by those skilled in the art and substantially the same components. Furthermore, the components described below can be appropriately combined. What is disclosed herein is merely an example, and it is needless to say that appropriate modifications within the gist of the disclosure at which those skilled in the art can easily arrive are encompassed in the range of the present disclosure. Widths, thicknesses, shapes, and the like of the parts can be schematically illustrated in the drawings in comparison with actual aspects for clearer explanation. They are, however, merely examples and do not limit interpretation of the present disclosure. In the present specification and the drawings, the same reference signs denote components similar to those described before with reference to the drawing that has been already described, and detailed explanation thereof can be appropriately omitted.

### First Embodiment

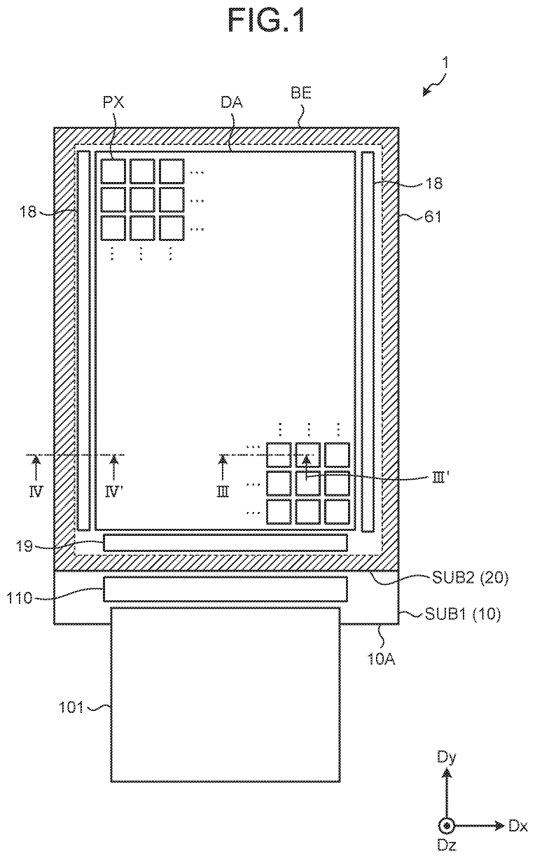

FIG. 1 is a plan view schematically illustrating a display device according to a first embodiment. As illustrated in FIG. 1, a display device 1 includes an array substrate SUB1 and a counter substrate SUB2. The counter substrate SUB2 is provided above the array substrate SUB1 in an overlapping manner in a third direction Dz.

In the embodiment, a first direction Dx is a direction along one side (short side) of the array substrate SUB1 (first flexible substrate 10). A second direction Dy is a direction intersecting with (or orthogonal to) the first direction Dx. The second direction Dy is not limited thereto and may intersect with the first direction Dx at an angle other than 90°. A plane defined by the first direction Dx and the second direction Dy is parallel with a plane of the array substrate SUB1. The third direction Dz orthogonal to the first direction Dx and the second direction Dy corresponds to the thickness direction of the array substrate SUB1.

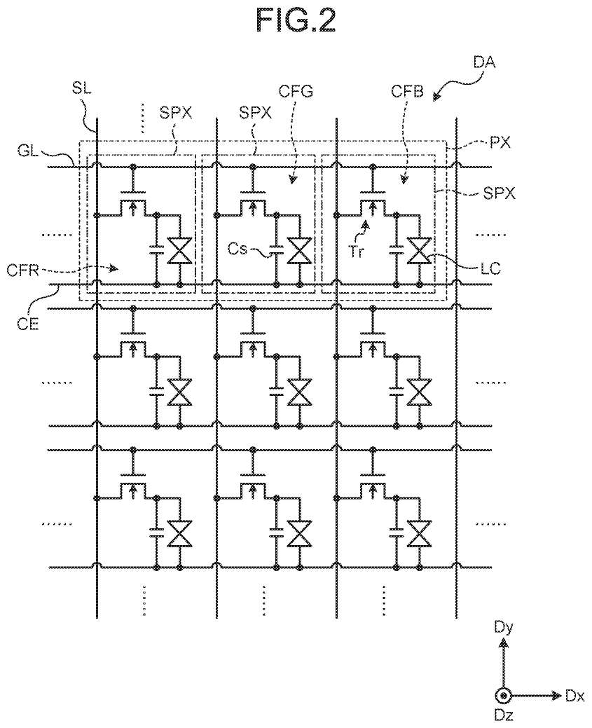

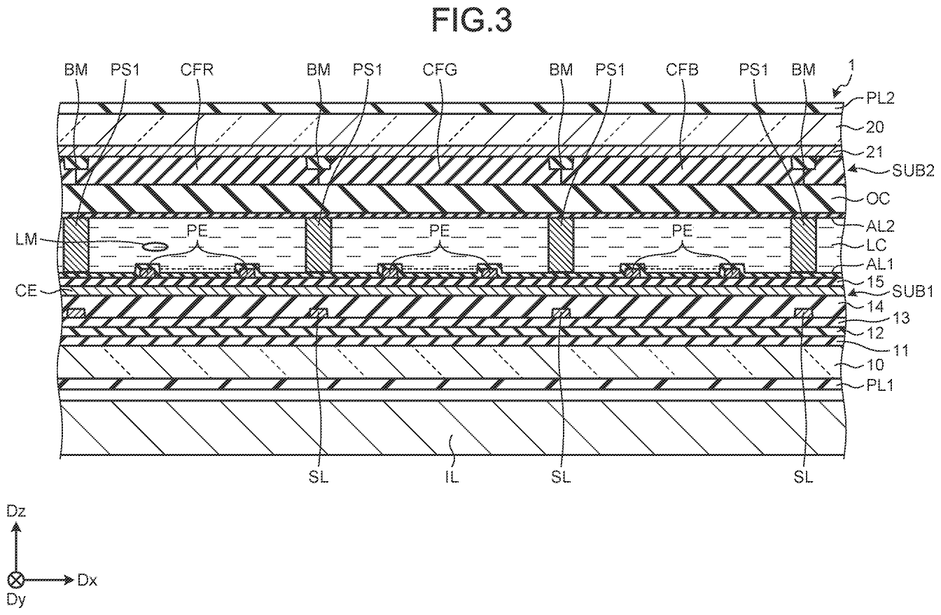

The array substrate SUB1 is a drive circuit substrate for driving a plurality of pixels PX. The array substrate SUB1 includes a first flexible substrate 10 as a base body. The array substrate SUB1 includes switching elements Tr and various wiring lines such as scan lines GL and pixel signal lines SL (see FIG. 2) provided to the first flexible substrate 10. The counter substrate SUB2 is provided so as to face the array substrate SUB1 and includes a second flexible substrate 20 as a base body. The counter substrate SUB2 includes color filters CF and a light shielding layer BM (see FIG. 3) provided to the second flexible substrate 20. The first flexible substrate 10 and the second flexible substrate 20 are resin substrates having flexibility and are made of a material having translucency, for example, polyimide resin is used.

The length of the array substrate SUB1 in the second direction Dy is larger than the length of the counter substrate SUB2 in the second direction Dy. As illustrated in FIG. 1, the first flexible substrate 10 has a protruding portion 10A. The protruding portion 10A protrudes to the outer side relative to the second flexible substrate 20 when seen from above.

A driver integrated circuit (IC) 110 and a wiring substrate 101 are provided to the protruding portion 10A. The driver IC 110 includes a control circuit that controls display of the display device 1. The driver IC 110 is mounted on the first flexible substrate 10 using an anisotropic conductive film (ACF), for example. The driver IC 110 is not limited to this example and may be mounted on the wiring substrate 101. The position of the driver IC 110 is not limited thereto, and the driver IC 110 may be provided above a control substrate or a flexible substrate outside the module, for example.

The wiring substrate 101 is configured by a flexible printed circuits (FPC), for example. The wiring substrate 101 is coupled to a plurality of terminals of the first flexible substrate 10.

In the display device 1, a peripheral region BE is provided on the outer side of a display region DA. The display region DA is formed to have a quadrangular shape but the outer shape of the display region DA is not limited thereto. For example, the display region DA may have a substantially quadrangular shape with curved corners or may have a cutout. Alternatively, the display region DA may have a polygonal shape or another shape such as a circular shape and an elliptic shape.

The display region DA is a region for displaying an image and is a region in which a plurality of pixels PX are provided. The pixels PX are arrayed in a matrix with a row-column configuration in the display region DA. The peripheral region BE indicates a region on the inner side of the outer circumference of the array substrate SUB1 and on the outer side of the display region DA. The peripheral region BE may have a frame shape surrounding the display region DA, and in this case, the peripheral region BE can also be referred to as a frame region.

The peripheral region BE is located between an end portion of the first flexible substrate 10 and the display region DA. Gate drivers 18 and a signal line selection circuit 19 are provided in the peripheral region BE. The gate drivers 18 scan the scan lines GL (see FIG. 2) provided in the display region DA based on a control signal from the driver IC 110. Although two gate drivers 18 are provided with the display region DA interposed therebetween, only any one of them may be provided. The signal line selection circuit 19 is, for example, a multiplexer and couples the pixel signal lines SL (see FIG. 2) and the driver IC 110.

The array substrate SUB1 and the counter substrate SUB2 adhere to each other with a seal member 51. In FIG. 1, the seal member 51 is hatched. The seal member 51 is provided in the peripheral region BE so as to surround the display region DA. A liquid crystal layer LC (see FIG. 3) is provided on the inner side of the seal member 51 between the array substrate SUB1 and the counter substrate SUB2. Although the seal member 51 is disposed so as not to overlap with the gate drivers 18 and the signal line selection circuit 19 in the illustrated example, they may be provided so as to overlap with the seal member 51.

FIG. 2 is a circuit diagram illustrating pixel array of the display region. The switching elements Tr of respective sub pixels SPX, the pixel signal lines SL, the scan lines GL illustrated in FIG. 2, and the like are formed in the array substrate SUB1. The pixel signal lines SL extend in the second direction Dy. The pixel signal lines SL are wiring lines for supplying pixel signals to pixel electrodes PE (see FIG. 3). The scan lines GL extend in the first direction Dx. The scan lines GL are wiring lines for supplying drive signals (scan signals) for driving the switching elements Tr.

Each pixel PX includes the sub pixels SPX. Each sub pixel SPX includes the switching element Tr and a capacitor of the liquid crystal layer LC. The switching element Tr is formed by a thin film transistor and, in this example, is formed by an n-channel metal oxide semiconductor (MOS) TFT. An insulating film 15 is provided between the pixel electrodes PE and a common electrode CE illustrated in FIG. 3, and they form holding capacitors Cs illustrated in FIG. 2.

Color regions colored in three colors of red (R), green (G), and blue (B), for example, are cyclically arrayed as color filters CFR, CFG, and CFB. The color regions of the three colors of R, G, and B as one set are made to respectively correspond to the sub pixels SPX. A set of sub pixels SPX corresponding to the color regions of the three colors configures the pixel PX. The color filters may include color regions of equal to or more than four colors. In this case, the pixel PX may include equal to or more than four sub pixels SPX.

FIG. 3 is a cross-sectional view illustrating the schematic cross-sectional configuration of the display device. FIG. 3 is a cross-sectional view cut along line of FIG. 1, for example. As illustrated in FIG. 3, the display device 1 includes a first polarizing plate PL1, a second polarizing plate PL2, and an illumination device IL. The counter substrate SUB2 is disposed so as to face the surface of the array substrate SUB1 in the vertical direction. The liquid crystal layer LC is provided between the array substrate SUB1 and the counter substrate SUB2. In other words, the first flexible substrate 10 and the second flexible substrate 20 are disposed so as to face each other in the third direction Dz. The liquid crystal layer LC as a display function layer is disposed between the first flexible substrate 10 and the second flexible substrate 20. The illumination device IL, the first polarizing plate PL1, the array substrate SUB1, the counter substrate SUB2, and the second polarizing plate PL2 are stacked in this order in the third direction Dz.

The array substrate SUB1 faces the illumination device IL, and the counter substrate SUB2 is located on the display surface side. The illumination device IL emits light toward the array substrate SUB1. For example, a side light-type backlight or a direct-type backlight can be applied to the illumination device IL. Although various modes can be applied to the illumination device IL, explanation of the detailed configuration thereof is omitted.

An optical element including the first polarizing plate PL1 faces the first flexible substrate 10. To be more specific, the first polarizing plate PL1 is disposed on the outer surface of the first flexible substrate 10 or on the surface thereof facing the illumination device IL. An optical element including the second polarizing plate PL2 faces the second flexible substrate 20. To be more specific, the first polarizing plate PL1 is disposed on the outer surface of the second flexible substrate 20 or on the surface thereof on the observation position side. A first polarization axis of the first polarizing plate PL1 and a second polarization axis of the second polarizing plate PL2 have a positional relation of crossed Nicols in an X-Y plane, for example. The optical elements including the first polarizing plate PL1 and the second polarizing plate PL2 may include another optical function element such as a phase difference plate.

The array substrate SUB1 includes a first barrier film 11, insulating films 12, 13, 14, and 15, the pixel signal lines SL, the pixel electrodes PE, the common electrode CE, a first orientation film AL1 and the like on the side of the first flexible substrate 10 that faces the counter substrate SUB2. The array substrate SUB1 includes the first polarizing plate PL1 on the side of the first flexible substrate 10 that is opposite to the counter substrate SUB2.

In the present specification, the direction toward the second flexible substrate 20 from the first flexible substrate 10 in the direction perpendicular to the first flexible substrate 10 is an “upper-side direction” or simply an “upward direction”. The direction toward the first flexible substrate 10 from the second flexible substrate 20 is a “lower-side direction” or simply a “downward direction”. The expression “when seen from above” indicates a positional relation when seen from the direction perpendicular to the first flexible substrate 10.

The first barrier film 11 is provided so as to make contact with the surface of the first flexible substrate 10 that faces the counter substrate SUB2 and cover the surface of the first flexible substrate 10. The first barrier film 11 is an inorganic insulating film that prevents entrance of moisture and the like into the display device 1 from the first flexible substrate 10 side. The first barrier film 11, the insulating films 12 and 13, and the insulating film 15 are made of, for example, an inorganic material having translucency, such as silicon oxide and silicon nitride.

The insulating film 12 is provided above the first barrier film 11. The insulating film 13 is provided above the insulating film 12. The pixel signal lines SL are provided above the insulating film 13. The insulating film 14 is provided above the insulating film 13 and covers the pixel signal lines SL. The insulating film 14 is an organic insulating film made of a resin material having translucency and has a film thickness that is larger than those of the other insulating films made of the inorganic material. Although not illustrated in FIG. 3, the scan lines GL are provided above the insulating film 12.

The common electrode CE is provided above the insulating film 14. The common electrode CE is provided continuously over the display region DA. The common electrode CE is not, however, limited to being provided in this manner and may have slits to be divided into a plurality of parts. The common electrode CE is covered by the insulating film 15.

The pixel electrodes PE are provided above the insulating film 15 and face the common electrode CE with the insulating film 15 interposed therebetween. The pixel electrodes PE and the common electrode CE are made of, for example, a conductive material having translucency, such as indium tin oxide (ITO) and indium zinc oxide (IZO). The first orientation film AL1 covers the pixel electrodes PE and the insulating film 15.

The counter substrate SUB2 includes a second barrier film 21, the light shielding layer BM, the color filters CFR, CFG, and CFB, an overcoat layer OC, and a second orientation film AL2 on the side of the second flexible substrate 20 that faces the array substrate SUB1. The counter substrate SUB2 includes the second polarizing plate PL2 on the side of the second flexible substrate 20 that is opposite to the array substrate SUB1.

The second barrier film 21 is provided so as to make contact with the surface of the second flexible substrate 20 that faces the array substrate SUB1 and cover the surface of the second flexible substrate 20. The second barrier film 21 is provided as an inorganic insulating film that prevents entrance of moisture and the like into the display device 1 from the second flexible substrate 20 side. The second barrier film 21 is made of an inorganic material similar to that of the first barrier film 11.

The light shielding layer BM is located on the side of the second flexible substrate 20 that faces the array substrate SUB1 in the display region DA. The light shielding layer BM defines openings that respectively face the pixel electrodes PE. The pixel electrodes PE are partitioned for the respective openings of the pixels PX. The light shielding layer BM is made of a resin material in black color or a metal material having a light shielding property.

The color filters CFR, CFG, and CFB are located on the side of the second flexible substrate 20 that faces the array substrate SUB1, and end portions thereof overlap with the light shielding layer BM. As an example, the color filters CFR, CFG, and CFB are made of resin materials colored in red, green, and blue, respectively. The second barrier film 21 is provided between the second flexible substrate 20 as well as the light shielding layer BM and the color filters CFR, CFG, and CFB.

The overcoat layer OC covers the color filters CFR, CFG, and CFB. The overcoat layer OC is made of a resin material having translucency. The second orientation film AL2 covers the overcoat layer OC. The first orientation film AL1 and the second orientation film AL2 are made of, for example, a material exhibiting horizontal orientation property.

The array substrate SUB1 and the counter substrate SUB2 are disposed such that the first orientation film AL1 and the second orientation film AL2 face each other. First spacers PS1 are provided on the surface of the second orientation film AL2 that faces the first orientation film AL1.

The first spacers PS1 are formed at the same height. The first spacers PS1 are provided so as to make contact with the first orientation film AL1 in the third direction Dz. A distance between the substrates can thereby be kept even with the configuration in which the array substrate SUB1 includes the first flexible substrate 10 as the base body and the counter substrate SUB2 includes the second flexible substrate 20 as the base body. Second spacers PS2 may be provided on the surface of the first orientation film AL1 that faces the second orientation film AL2. In this case, the second spacers PS2 are formed to be lower than the first spacers PS1 are. With such second spacers PS2, when both substrates facing each other deviate from each other, the second spacers PS2 function as stoppers to reduce the deviation amount of the substrates.

The liquid crystal layer LC is enclosed between the first orientation film AL1 and the second orientation film AL2. The liquid crystal layer LC is made of a negative liquid crystal material having a negative dielectric anisotropy or a positive liquid crystal material having a positive dielectric anisotropy.

For example, when the liquid crystal layer LC is made of the negative liquid crystal material and a state in which no voltage is applied to the liquid crystal layer LC is made, liquid crystal molecules LM are initially oriented in such a direction that long axes thereof extend along the first direction Dx in the X-Y plane. On the other hand, in a state in which the voltage is applied to the liquid crystal layer LC, that is, in an ON state in which an electric field is formed between the pixel electrodes PE and a detection electrode DE, the liquid crystal molecules LM receive influences of the electric field and orientation states thereof are changed. In the ON state, a polarization state of incident linearly polarized light is changed in accordance with the orientation states of the liquid crystal molecules LM when it passes through the liquid crystal layer LC.

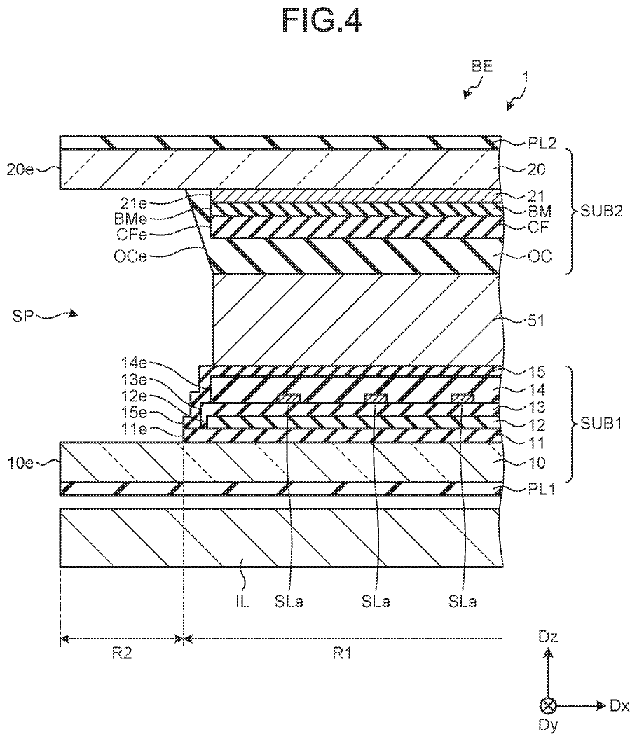

Next, the cross-sectional configuration in the peripheral region BE of the display device 1 is described. FIG. 4 is a cross-sectional view cut along line IV-IV′ in FIG. 1. As illustrated in FIG. 4, the first barrier film 11 and the insulating films 12, 13, 14, and 15 are provided to be continuous from the display region DA to the peripheral region BE in the array substrate SUB1. The first barrier film 11 and the insulating films 12, 13, 14, and 15 are provided on the inner side (display region DA side) of a side surface 10e of the first flexible substrate 10.

To be more specific, the first flexible substrate 10 has a superimposition region R1 and a non-superimposition region R2. The superimposition region R1 is a region in which the first barrier film 11 is provided. The insulating films 12, 13, 14, and 15 are stacked above the first barrier film 11 in the superimposition region R1. Signal lines SLa are provided above the insulating film 13 in the peripheral region BE. The signal lines SLa are wiring lines for supplying scan signals to the gate drivers 18 (see FIG. 1), for example. Although not illustrated in the drawing, another wiring line may be provided in a layer differing from that of the signal lines SLa, for example, on the insulating film 12. The seal member 51 is provided above the insulating film 15, and the array substrate SUB1 and the counter substrate SUB2 closely adhere to each other with the seal member 51.

A side surface 11e of the first barrier film 11 is located on the outer side of side surfaces 12e, 13e, and 14e of the respective insulating films 12, 13, and 14 in the superimposition region R1. A side surface 15e of the insulating film 15 is provided so as to cover the side surfaces 12e, 13e, and 14e of the respective insulating films 12, 13, and 14 and is provided at a position aligned with the side surface 11e of the first barrier film 11. The insulating film 15 and the first barrier film 11 make contact with each other on the side surface 11e side of the first barrier film 11. The insulating film 15 thereby covers the insulating film 14 as the organic insulating film, thereby functioning as a barrier film that prevents entrance of moisture into the insulating film 14.

The non-superimposition region R2 is a region between the side surface 11e of the first barrier film 11 and the side surface 10e of the first flexible substrate 10 and is a region in which the first barrier film 11 is not provided. The insulating films 12, 13, 14, and 15 are not also provided in the non-superimposition region R2. That is to say, a space SP surrounded by the first flexible substrate 10, the second flexible substrate 20 of the counter substrate SUB2, and the side surface of the seal member 51 is provided in the non-superimposition region R2.

The second barrier film 21 is provided in a region of the second flexible substrate 20 that overlaps with the superimposition region R1. The light shielding layer BM and the color filter CF as a coloring layer are stacked to the surface of the second barrier film 21 that faces the array substrate SUB1 in the superimposition region R1. A side surface BMe of the light shielding layer BM and a side surface CFe of the color filter CF are provided at positions aligned with a side surface 21e of the second barrier film 21. The overcoat layer OC covers the second barrier film 21, the light shielding layer BM, and the color filter CF and is provided in a region overlapping with the superimposition region R1. A side surface OCe of the overcoat layer OC covers the side surface 21e of the second barrier film 21, the side surface BMe of the light shielding layer BM, and the side surface CFe of the color filter CF.

The second barrier film 21, the coloring layer (the light shielding layer BM and the color filter CF), and the overcoat layer OC are not provided in at least a part of a region of the second flexible substrate 20 that overlaps with the non-superimposition region R2. The side surface OCe of the overcoat layer OC is located on the inner side of a side surface 20e of the second flexible substrate 20.

As described above, in the embodiment, the non-superimposition region R2 in which the first barrier film 11 is not formed is provided in a peripheral edge portion of the first flexible substrate 10. For example, even when force or heat is applied to the side surface 10e of the first flexible substrate 10 in a manufacturing process of the display device 1, the force or heat is not applied directly to the first barrier film 11, thereby preventing generation of cracks in the first barrier film 11. As a result, growth of the cracks in the first barrier film 11 can be prevented, and disconnection of the pixel signal lines SL, the scan lines GL, and the like provided as a circuit layer in the display region DA can be prevented. Accordingly, deterioration in reliability of the display device 1 can be prevented.

Similarly, in the embodiment, the second barrier film 21 is not formed in a region overlapping with the non-superimposition region R2 in a peripheral edge portion of the second flexible substrate 20. For example, even when force or heat is applied to the side surface 20e of the second flexible substrate 20 in the manufacturing process of the display device 1, the force or heat is not applied directly to the second barrier film 21, thereby preventing generation of cracks in the second barrier film 21. As a result, growth of the cracks in the second barrier film 21 can be prevented, and deterioration in reliability of the display device 1 can be prevented.

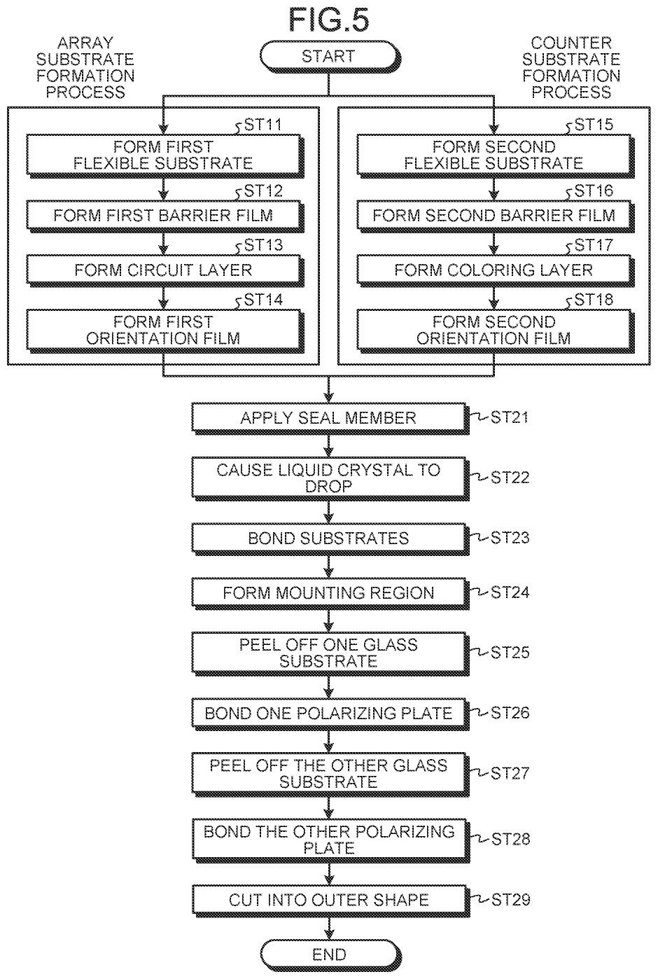

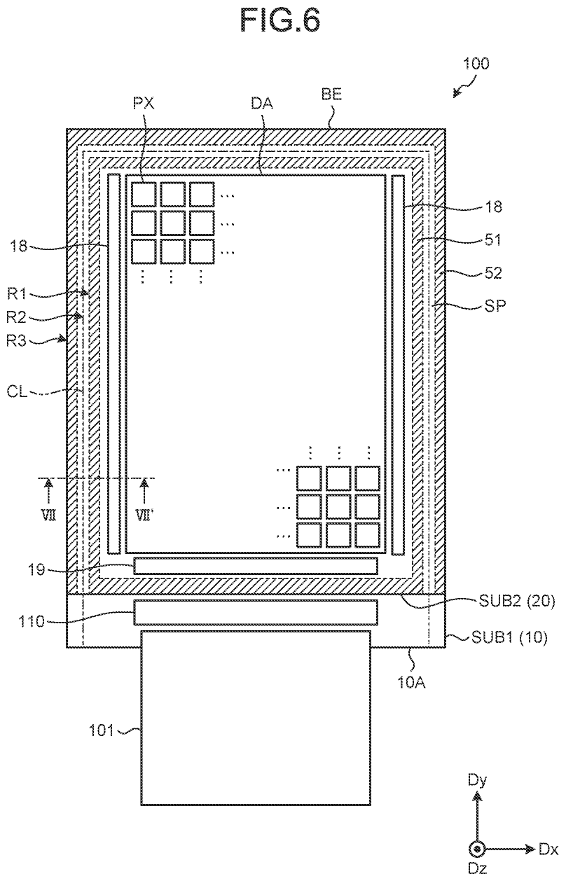

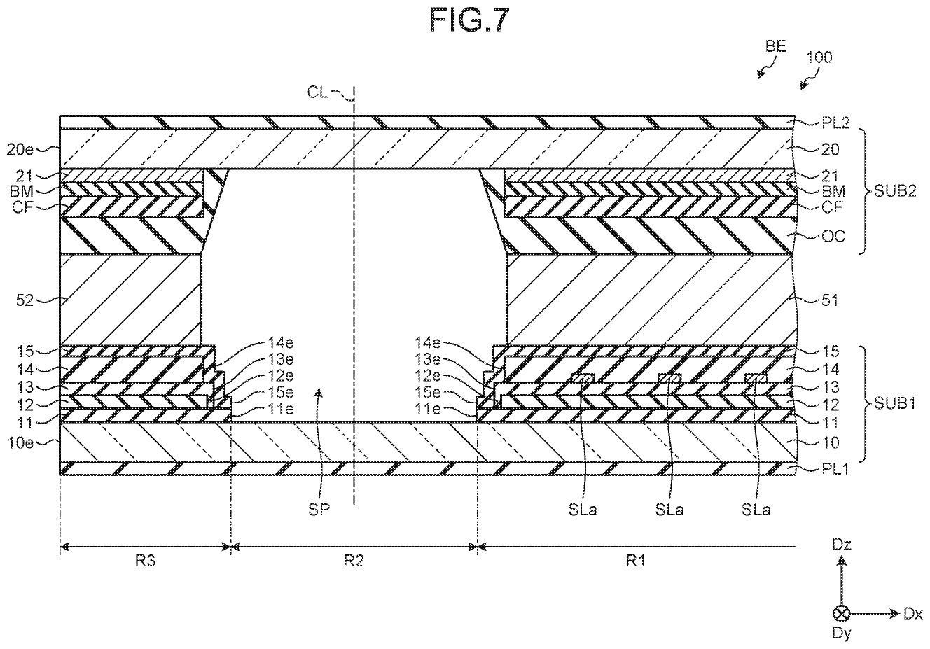

Next, the manufacturing process of the display device 1 is described. FIG. 5 is a flowchart illustrating an example of a method for manufacturing the display device in the first embodiment. FIG. 6 is a plan view schematically illustrating the display device before outer shape cutting. FIG. 7 is a cross-sectional view cut along line VII-VII′ in FIG. 6. In the example illustrated in FIG. 5, the manufacturing process includes a process of forming the array substrate SUB1 (step ST11 to step ST14), a process of forming the counter substrate SUB2 (step ST15 to step ST18), and a process of bonding the array substrate SUB1 and the counter substrate SUB2 to assemble the display device 1 (step ST21 to step ST29).

First, the process of forming the array substrate SUB1 (the array substrate SUB1 before the outer shape cutting) is described. A material of the first flexible substrate 10 is applied onto the upper surface of a support substrate (for example, a glass substrate), and the applied material is hardened to form the first flexible substrate 10 (step ST11). As an example, a composition containing a polyamide acid is applied onto the glass substrate and is subject to heat processing at a temperature of about 300° C. to 500° C. for imidization to form the first flexible substrate 10 formed by a polyimide film.

The first barrier film 11 is formed above the first flexible substrate 10 (step ST12). The first barrier film 11 is formed over the entire region of the display region DA and the peripheral region BE of the first flexible substrate 10.

The switching elements Tr, the pixel signal lines SL, the scan lines GL, the common electrode CE, the pixel electrodes PE, various insulating films, and the like are stacked above the first barrier film 11 to form the circuit layer (step ST13). As illustrated in FIG. 6 and FIG. 7, the first barrier film 11 is removed along an outer shape cut line CL in the array substrate SUB1 in a display device 100 before the outer shape cutting. The superimposition region R1, the non-superimposition region R2, and a superimposition region R3 are thereby formed. The superimposition region R3 is a region between the non-superimposition region R2 and the side surface 10e of the first flexible substrate 10 and is configured by stacking the first barrier film 11, and the insulating film 12 to the insulating film 15 similarly to the superimposition region R1. The non-superimposition region R2 is formed by removing the first barrier film 11 and the insulating film 15 stacked above the first flexible substrate 10 in the same process. The side surface 11e and the side surface 15e thereby overlap with each other.

The outer shape cut line CL is a virtual line along which cutting is performed into the outer shape of the display device 1 and is provided along three sides of the array substrate SUB1 before the outer shape cutting. The outer shape cut line CL is not, however, limited thereto, and it is sufficient that the outer shape cut line CL is provided along at least one side of the array substrate SUB1. The outer shape cut line CL may alternatively be formed along four sides surrounding the display region DA. That is to say, it is sufficient that the non-superimposition region R2 is provided along at least one side of the array substrate SUB1. The non-superimposition region R2 may alternatively be formed along the four sides surrounding the display region DA.

A material of the first orientation film AL1 is applied onto the circuit layer and is hardened to form the first orientation film AL1 (step ST14). The array substrate SUB1 before the outer shape cutting is formed with the above-mentioned processes.

Then, the process of forming the counter substrate SUB2 (the counter substrate SUB2 before the outer shape cutting) is described. Similarly to the process at step ST11, the second flexible substrate 20 is formed above a support substrate such as a glass substrate, for example (step ST15).

The second barrier film 21 is formed above the second flexible substrate 20 (step ST16). The second barrier film 21 is formed over the entire region of the display region DA and the peripheral region BE of the second flexible substrate 20.

The light shielding layer BM and the color filters CF are stacked to form the coloring layer above the second barrier film 21 (step ST17). As illustrated in FIG. 7, the second barrier film 21 and the coloring layer are removed along the outer shape cut line CL in the counter substrate SUB2 in the display device 100 before the outer shape cutting. With this removal, the second barrier film 21 and the coloring layer are formed in regions overlapping with the superimposition region R1 and the superimposition region R3 whereas the second barrier film 21 and the coloring layer are not formed in a region overlapping with the non-superimposition region R2. Thereafter, the overcoat layer OC is provided. The overcoat layer OC is provided in the superimposition region R1 and the superimposition region R3 and covers the second barrier film 21 and the coloring layer. The overcoat layer OC is not provided in the non-superimposition region R2. In other words, the second flexible substrate 20 faces the first flexible substrate 10 through a space SP at least a position along the outer shape cut line CL in the non-superimposition region R2.

A material of the second orientation film AL2 is applied onto the overcoat layer OC and is hardened to form the second orientation film AL2 (step ST18). The counter substrate SUB2 before the outer shape cutting is formed with the above-mentioned processes.

Subsequently, the process of bonding the array substrate SUB1 and the counter substrate SUB2 to assemble the display device 1 is described. Seal members 51 and 52 are applied to any one of the array substrate SUB1 and the counter substrate SUB2 (step ST21). The seal members 51 and 52 are respectively formed in the superimposition region R1 and the superimposition region R3 and are not provided in the non-superimposition region R2.

A liquid crystal material of the liquid crystal layer LC is caused to drop in an inner region surrounded by the seal member 51 (step ST22). The array substrate SUB1 and the counter substrate SUB2 are bonded to each other (step ST23), and the seal members 51 and 52 are hardened. A method for injecting the liquid crystal layer LC is not limited to the process at step ST22. For example, a vacuum injection method in which the array substrate SUB1 and the counter substrate SUB2 are bonded to each other first, and then, the liquid crystal layer LC is enclosed may be employed.

Thereafter, a portion of the counter substrate SUB2 along one side is cut, so that the protruding portion 10A of the array substrate SUB1 is formed. The protruding portion 10A is formed as a mounting region in which the driver IC 110 and the wiring substrate 101 are mounted (step ST24).

Then, one glass substrate (for example, the glass substrate of the counter substrate SUB2) is peeled off (step ST25). To be specific, laser light is emitted to the second flexible substrate 20 through the translucent glass substrate. The second flexible substrate 20 thereby absorbs the laser light and slightly decomposes the substrate. A void is generated in an interface between the second flexible substrate 20 and the glass substrate, and the glass substrate is peeled off from the second flexible substrate 20. The second polarizing plate PL2 is bonded onto the second flexible substrate 20 (step ST26).

Similarly to step ST25, the other glass substrate (for example, the glass substrate of the array substrate SUB1) is peeled off (step ST27). To be specific, the glass substrate is peeled off from the first flexible substrate 10. The first polarizing plate PL1 is bonded onto the first flexible substrate 10 (step ST28).

The array substrate SUB1 and the counter substrate SUB2 that have been bonded to each other are cut along the outer shape cut line CL to be formed into the outer shape of the display device 1 (step ST29). The outer shape cutting process is performed by emitting laser light by a laser device and cutting the array substrate SUB1 and the counter substrate SUB2 along three sides thereof. After that, the driver IC 110 and the wiring substrate 101 are mounted on the protruding portion 10A, and the process of assembling the display device 1 is completed.

In the embodiment, the non-superimposition region R2 is provided along the outer shape cut line CL, thereby preventing generation of cracks in the first barrier film 11 and the second barrier film 21 by emission of the laser light in the outer shape cutting process. In the non-superimposition region R2, the insulating film 14 as the organic insulating film and the coloring layer made of the organic resin material are not provided and the space SP is formed between the array substrate SUB1 and the counter substrate SUB2. Formation of a carbonizing layer with emission of the laser light or scattering of the carbonizing layer to surrounding areas can therefore be prevented.

The above-mentioned manufacturing method is merely an example and can be appropriately modified. Although the outer shape cutting is performed for one individual piece as an example in FIG. 6, the manufacturing method is not limited thereto. The manufacturing method can also be applied to a process of cutting a mother board on which a plurality of regions to be formed as individual pieces are arrayed to form a large number of individual pieces from one mother board.

### Second Embodiment

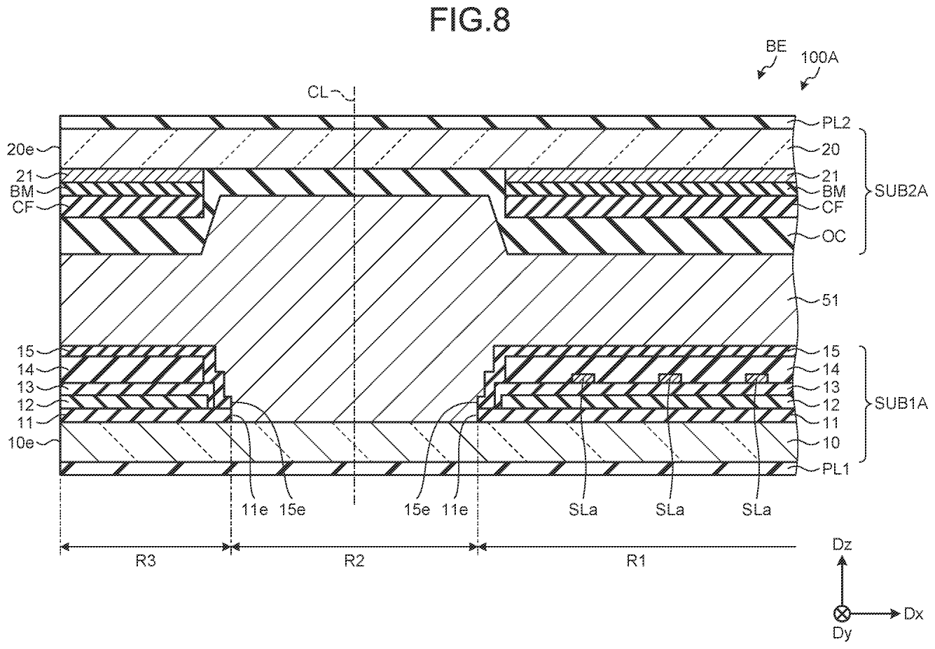

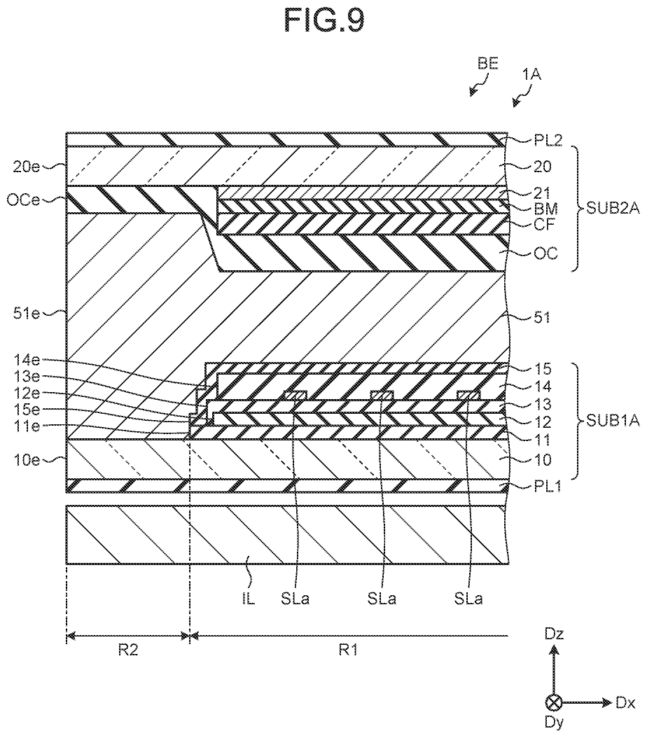

FIG. 8 is a cross-sectional view for explaining an example of a method for manufacturing a display device according to a second embodiment. FIG. 9 is a cross-sectional view schematically illustrating the display device in the second embodiment. In the following description, the same reference signs denote the same components described in the above-mentioned embodiment, and overlapped explanation thereof is omitted.

As illustrated in FIG. 8, the seal member 51 and the overcoat layer OC are provided also in the non-superimposition region R2 in a display device 100A before outer shape cutting in the second embodiment. That is to say, the overcoat layer OC is provided so as to cover the entire region of the surface of a counter substrate SUB2A that faces an array substrate SUB1A. The seal member 51 is formed so as to be continuous over the superimposition region R1, the non-superimposition region R2, and the superimposition region R3 between the array substrate SUB1A and the counter substrate SUB2A. In other words, the space SP is not formed but the first flexible substrate 10, the seal member 51, the overcoat layer OC, and the second flexible substrate 20 are stacked in this order between the first flexible substrate 10 and the second flexible substrate 20 in the non-superimposition region R2.

As illustrated in FIG. 9, in a display device 1A after the outer shape cutting, the seal member 51 and the overcoat layer OC are provided so as to fill the non-superimposition region R2. The seal member 51 is provided so as to make contact with the surface of the first flexible substrate 10 that faces the second flexible substrate 20. A side surface 51e of the seal member 51 and the side surface OCe of the overcoat layer OC are provided at positions aligned with the side surface 10e of the first flexible substrate 10 and the side surface 20e of the second flexible substrate 20.

In the embodiment, a process of patterning the seal member 51 and the overcoat layer OC can be omitted to simplify a process of forming the counter substrate SUB2A and an assembly process. End portions of the first flexible substrate 10 and the second flexible substrate 20 are supported on the seal member 51 and the overcoat layer OC, so that the display device 1A can be improved in the strength on the side of the side surfaces 10e and 20e.

### First Modification of Second Embodiment

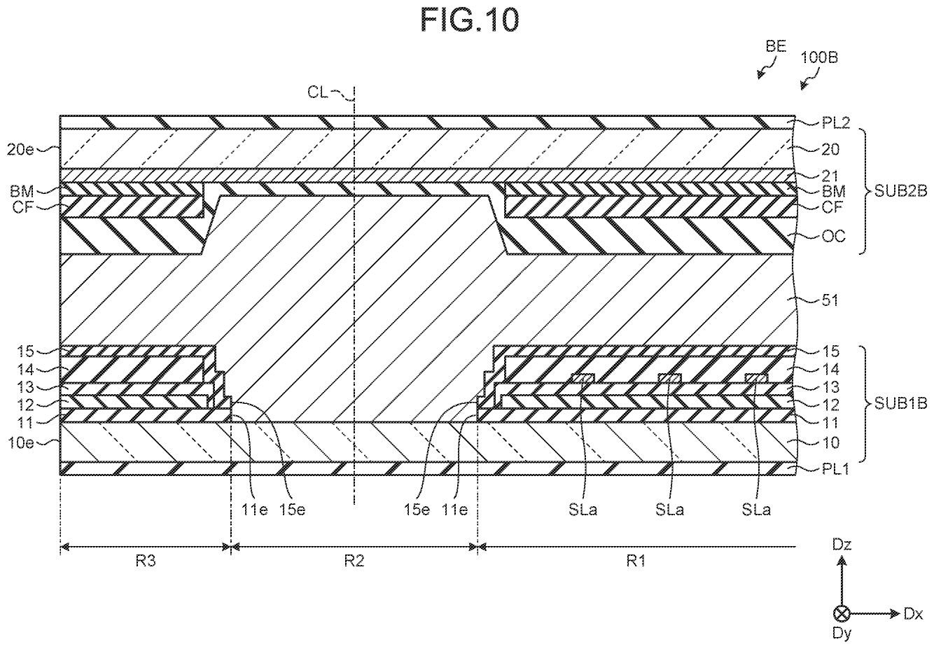

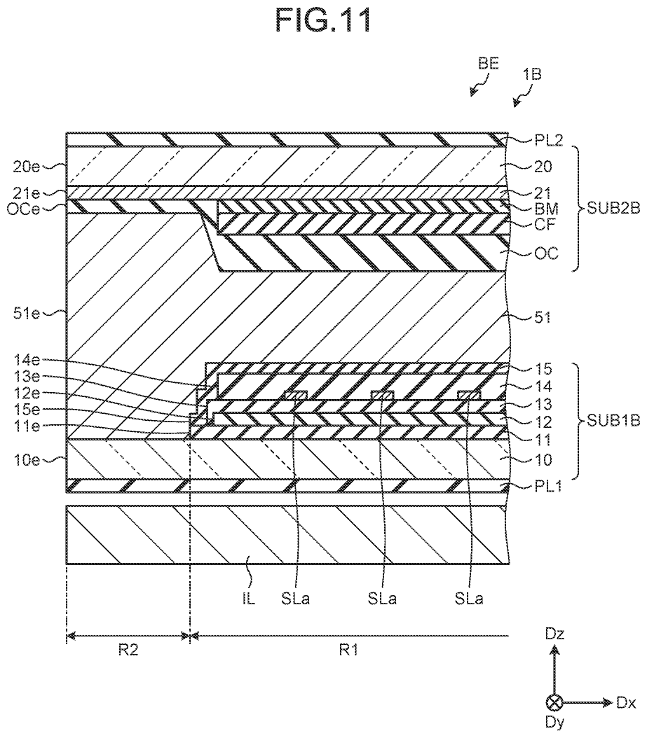

FIG. 10 is a cross-sectional view for explaining an example of a method for manufacturing a display device according to a first modification of the second embodiment. FIG. 11 is a cross-sectional view schematically illustrating the display device in the first modification of the second embodiment.

As illustrated in FIG. 10, a display device 100B before outer shape cutting in the first modification of the second embodiment is different from the above-mentioned second embodiment in the configuration in which the second barrier film 21 of a counter substrate SUB2B is provided also in a region overlapping with the non-superimposition region R2. That is to say, the second barrier film 21 is formed to be continuous over the superimposition region R1, the non-superimposition region R2, and the superimposition region R3. In other words, the first flexible substrate 10, the seal member 51, the overcoat layer OC, the second barrier film 21, and the second flexible substrate 20 are stacked in this order in the non-superimposition region R2. The array substrate SUB1B has the similar configuration to that of the above-mentioned array substrate SUB1A.

As illustrated in FIG. 11, in a display device 1B after the outer shape cutting, the second barrier film 21 is provided between the overcoat layer OC and the second flexible substrate 20 in the non-superimposition region R2. The side surface 21e of the second barrier film 21 is provided at a position aligned with the side surface OCe of the overcoat layer OC and the side surface 20e of the second flexible substrate 20.

In the modification, a process of patterning the second barrier film 21 can be omitted to simplify a manufacturing process. Even when cracks are generated in the second barrier film 21 in the outer shape cutting, deterioration in reliability of the display device 1B can be prevented because no circuit layer is formed on the counter substrate SUB2B. The configuration in the modification can be applied also to the above-mentioned first embodiment.

### Third Embodiment

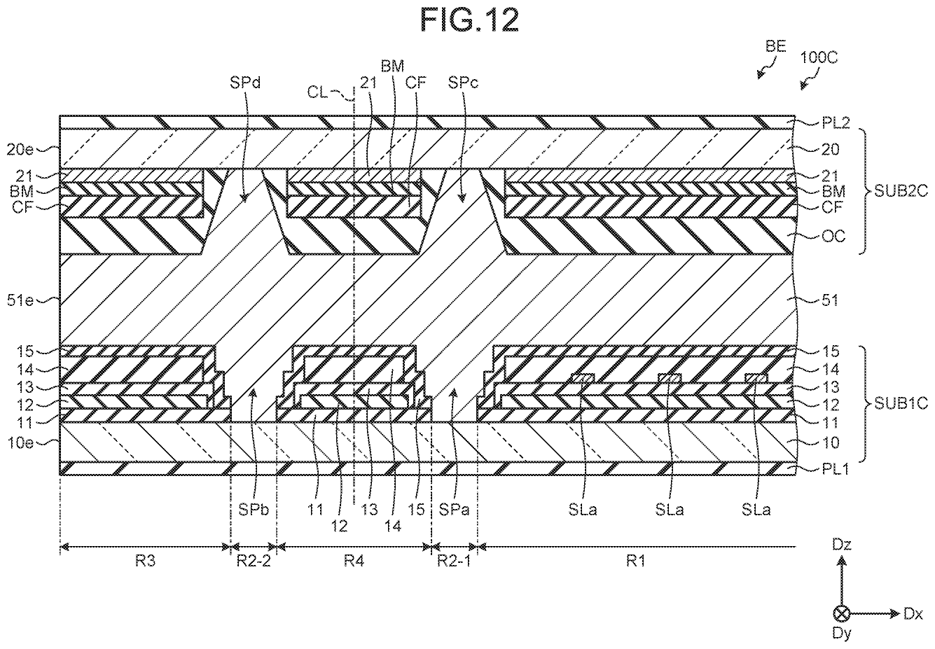

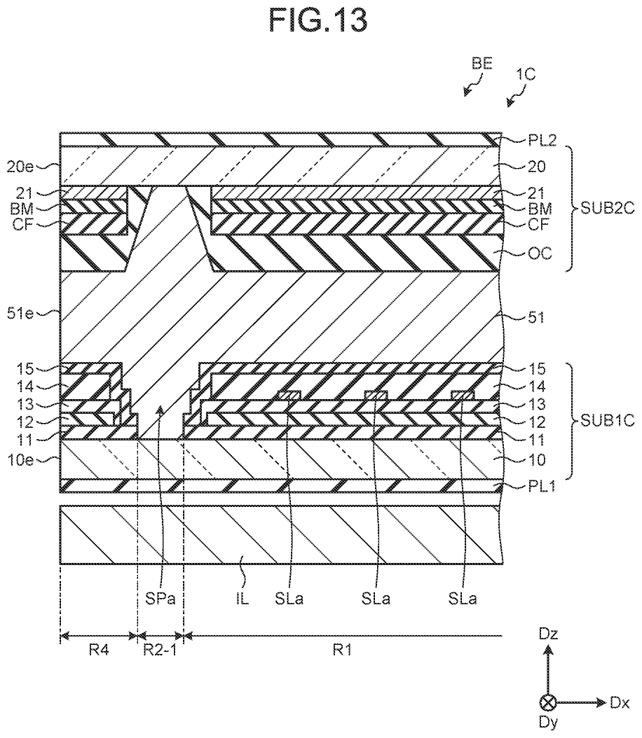

FIG. 12 is a cross-sectional view for explaining an example of a method for manufacturing a display device according to a third embodiment. FIG. 13 is a cross-sectional view schematically illustrating the display device in the third embodiment.

As illustrated in FIG. 12, a display device 100C before outer shape cutting in the third embodiment is different from the above-mentioned first embodiment and second embodiment in the configuration in which a superimposition region R4 is further provided between the superimposition region R1 and the superimposition region R3. A non-superimposition region R2-1 is formed between the superimposition region R4 and the superimposition region R1. A non-superimposition region R2-2 is formed between the superimposition region R4 and the superimposition region R3.

The superimposition region R4 has a similar multilayered configuration to those in the superimposition region R1 and the superimposition region R3. In an array substrate SUB1C, the first barrier film 11 and the insulating films 12, 13, 14, and 15 are stacked in this order above the first flexible substrate 10 in the superimposition region R4. The insulating film 15 is provided so as to cover the upper surfaces and the side surfaces of the insulating films 12, 13, and 14. The first barrier films 11 and the insulating films 12, 13, 14, and 15 in the array substrate SUB1C are provided above the first flexible substrate 10 so as to be distanced with spaces SPa and SPb therebetween.

The second barrier film 21, the light shielding layer BM, the color filter CF, and the overcoat layer OC are stacked in this order on the surface of the second flexible substrate 20 that faces the first flexible substrate 10 in the region of a counter substrate SUB2C that overlaps with the superimposition region R4. The overcoat layer OC is provided so as to cover the lower surfaces and the side surfaces of the second barrier film 21, the light shielding layer BM, and the color filter CF. In other words, a plurality of the second barrier films 21, a plurality of the light shielding layers BM, and a plurality of the color filters CF are provided on the lower surface of the second flexible substrate 20 so as to be distanced with spaces SPc and SPd therebetween.

In the third embodiment, the outer shape cut line CL is provided at a position aligned with the superimposition region R4. That is to say, in the outer shape cutting process, the array substrate SUB1C and the counter substrate SUB2C are cut at positions aligned with the inorganic insulating films such as the first barrier film 11 and the second barrier film 21 and the coloring layer formed by the light shielding layer BM and the color filter CF in the superimposition region R4.

As illustrated in FIG. 13, the side surfaces of the first barrier film 11 and the insulating films 12, 13, 14, and 15 are aligned with the side surface 10e of the first flexible substrate 10 in a display device 1C after the outer shape cutting. Similarly, the side surfaces of the second barrier film 21, the light shielding layer BM, the color filter CF, and the overcoat layer OC are aligned with the side surface 20e of the second flexible substrate 20.

In the embodiment, even when cracks are generated in the first barrier film 11 and the second barrier film 21 in the superimposition region R4 in the outer shape cutting process, growth of the cracks is prevented by the non-superimposition region R2-1. Generation of cracks can therefore be prevented in the first barrier film 11 and the second barrier film 21 in the superimposition region R1.

In the third embodiment, the outer shape cut line CL is provided at an intermediate position of the superimposition region R4 in the first direction Dx. The outer shape cut line CL is, however, not limited thereto. It is sufficient that at least parts of the non-superimposition regions R2-1 and R2-2 are located between the outer shape cut line CL and the superimposition region R1.

### Second Modification of Third Embodiment

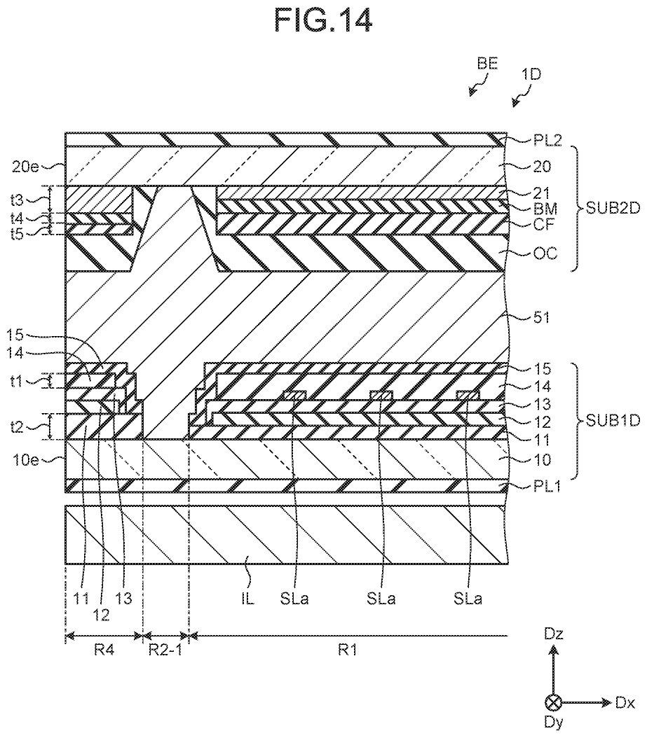

FIG. 14 is a cross-sectional view schematically illustrating a display device according to a second modification of the third embodiment. As illustrated in FIG. 14, a display device 1D in the second modification is different from the above-mentioned third embodiment in a relation of film thicknesses among layers in the superimposition region R4. To be specific, thickness t1 of the insulating film 14 in the superimposition region R4 is smaller than thickness t2 of the first barrier film 11 in the superimposition region R4 in an array substrate SUB1D. The thickness t1 of the insulating film 14 in the superimposition region R4 is smaller than the thickness of the insulating film 14 in the superimposition region R1. The thickness t2 of the first barrier film 11 in the superimposition region R4 is larger than the thickness of the first barrier film 11 in the superimposition region R1. The total film thickness of the first barrier film 11 to the insulating film 15 in the superimposition region R4 is thereby substantially equal to the total film thickness of the first barrier film 11 to the insulating film 15 in the superimposition region R1.

Formation of a carbonizing layer with emission of laser light to the insulating film 14 as the organic insulating film or scattering of the carbonizing layer to surrounding areas can therefore be prevented in the outer shape cutting process because the thickness t1 of the insulating film 14 is small in the superimposition region R4.

Similarly in a counter substrate SUB2D, the thickness of the coloring layer (each of a thickness t4 of the light shielding layer BM and a thickness t5 of the color filter CF) in the superimposition region R4 is smaller than a thickness t3 of the second barrier film 21. The thickness t4 of the light shielding layer BM in the superimposition region R4 is smaller than the thickness of the light shielding layer BM in the superimposition region R1. The thickness t5 of the color filter CF in the superimposition region R4 is smaller than the thickness of the color filter CF in the superimposition region R1. The thickness t3 of the second barrier film 21 in the superimposition region R4 is larger than the thickness of the second barrier film 21 in the superimposition region R1. The total film thickness of the second barrier film 21 and the coloring layer in the superimposition region R4 is thereby substantially equal to the total film thickness of the second barrier film 21 and the coloring layer in the superimposition region R1.

Formation of a carbonizing layer with emission of laser light to the coloring layer on the counter substrate SUB2D side or scattering of the carbonizing layer to surrounding areas can therefore be prevented in the outer shape cutting process.

The third embodiment and the second modification can be combined with the configuration in the above-mentioned first modification. That is to say, the second barrier film 21 and the overcoat layer OC may be provided in the non-superimposition region R2-1.

The display devices 1C and 1D in the third embodiment can employ the following aspect.

A display device comprising:

a first flexible substrate;

a second flexible substrate facing the first flexible substrate;

a display function layer provided between the first flexible substrate and the second flexible substrate; and

a first barrier film provided on a surface of the first flexible substrate that faces the second flexible substrate and formed by an inorganic insulating film, wherein

the first flexible substrate has a first superimposition region (superimposition region R1) in which the first barrier film is provided, a second superimposition region (superimposition region R4) that is separated from the first superimposition region and is located on a side of a side surface of the first flexible substrate and in which the first barrier film is provided, and a non-superimposition region R2-1 that is provided between the first superimposition region and the second superimposition region and in which the first barrier film is not provided.

In each of the above-mentioned embodiments, the display device has been described as an example of the electronic apparatus. The above-mentioned embodiments can, however, be applied also to other electronic apparatuses than the display device, such as an electrostatic detection device and an optical detection device.

Although the preferred embodiments of the present disclosure have been described above, the present disclosure is not limited by the embodiments. Contents disclosed in the embodiments are merely examples and various modifications can be made in a range without departing from the gist of the present disclosure. It is needless to say that appropriate modifications in a range without departing from the gist of the present disclosure belong to the technical range of the present disclosure. At least one of various omission, replacement, and modification of the components can be performed in a range without departing from the gist of the embodiments and modifications described above.

What is claimed is:

1. An electronic apparatus comprising:
a first flexible substrate;
a second flexible substrate facing the first flexible substrate; and
a first barrier film provided on a surface of the first flexible substrate that faces the second flexible substrate and formed by an inorganic insulating film, wherein
the first flexible substrate has a superimposition region in which the first barrier film is provided and a non-superimposition region that is provided between a side surface of the first barrier film and a side surface of the first flexible substrate and in which the first barrier film is not provided.

2. The electronic apparatus according to claim 1, further comprising:
a second barrier film provided on a surface of the second flexible substrate that faces the first flexible substrate and formed by an inorganic insulating film;
a coloring layer provided so as to overlap with the second barrier film; and
an overcoat layer covering the second barrier film and the coloring layer, wherein
the second barrier film, the coloring layer, and the overcoat layer are provided in a region overlapping with the superimposition region and are not provided in at least a part of a region overlapping with the non-superimposition region.

3. The electronic apparatus according to claim 1, further comprising:
at least equal to or more than one inorganic insulating film stacked above the first barrier film;
an organic insulating film covering the inorganic insulating film; and
an interlayer insulating film provided between a pixel electrode and a common electrode and covering a surface and a side surface of the organic insulating film, a side surface of the inorganic insulating film, and a side surface of the first barrier film.

4. The electronic apparatus according to claim 1, further comprising a seal member bonding the first flexible substrate and the second flexible substrate, wherein
a space surrounded by the first flexible substrate and the second flexible substrate facing each other and a side surface of the seal member is formed in the non-superimposition region.

5. The electronic apparatus according to claim 1, further comprising a seal member bonding the first flexible substrate and the second flexible substrate, wherein
the seal member is formed between the first flexible substrate and the second flexible substrate so as to make contact with a surface of the first flexible substrate that faces the second flexible substrate in the non-superimposition region.

6. The electronic apparatus according to claim 1, wherein the non-superimposition region is provided along at least one side among four sides surrounding a display region.

7. A method for manufacturing an electronic apparatus that includes:
a first flexible substrate; and
a second flexible substrate facing the first flexible substrate, the method comprising:
forming a first barrier film formed by an inorganic insulating film on the first flexible substrate to form a superimposition region in which the first barrier film is provided and a non-superimposition region that is provided between a side surface of the first barrier film and a side surface of the first flexible substrate and in which the first barrier film is not provided; and
bonding the first flexible substrate and the second flexible substrate and cutting the first flexible substrate and the second flexible substrate along the non-superimposition region.
